(19) United States
(12) Patent Application Publication
(10) Pub. No.: US 2013/0050858 A1
(43) Pub. Date: Feb. 28, 2013

(54) VIEWING APPARATUS ALLOWING CORRECT CERVICAL ALIGNMENT WHILE SUPINE

(71) Applicant: Shane Pickering, O'Fallon, MO (US)

(72) Inventor: Shane Pickering, O'Fallon, MO (US)

(21) Appl. No.: 13/355,534

(22) Filed: Jan. 22, 2012

Related U.S. Application Data
(60) Provisional application No. 61/527,723, filed on Aug. 26, 2011.

(51) Int. Cl. G02B 5/08

(52) U.S. Cl. 359/850

(57) ABSTRACT

A viewing apparatus is provided including a cervical support for supporting a neck of a user while lying supine. A frame is removeably attached to the cervical support. The frame is adjustable relative to the cervical support. A pair of minors is coupled to the frame. Each of the minors is separately adjustable relative to the cervical support.

### CROSS-REFERENCE TO RELATED APPLICATIONS

The present application claims priority to U.S. Provisional Application Ser. No. 61/527,723 filed Aug. 26, 2011 and having the title “VIEWER ALLOWING CORRECT CERVICAL ALIGNMENT WHILE SUPINE” the subject matter of which is incorporated in its entirety herein.

### BACKGROUND OF THE INVENTION

The subject matter herein relates generally to a viewing apparatus and, more particularly, to a viewing apparatus that allows correct cervical alignment while supine.

Often, individuals who are experiencing back and/or neck pain may be required to lie in a position that supports proper posture. Generally, the individuals are required to lie supine or flat on their back on a surface such as a hard floor or a bed or table that promotes proper posture. The individual may be required to lie in such a position for an extended period of time, for example forty-five minutes to an hour. Moreover, the individual may be required to lie in such a position multiple times a day. When lying in the supine position, a cervical support is generally positioned under the individual's neck. The cervical support promotes proper alignment of the spine while lying supine.

Lying in the supine position is beneficial to reducing neck and/or back pain in the individual. However, such positioning is not without its disadvantages. In particular, the supine position aligns the individual's line of view at approximately ninety degrees with respect to the individual's body. Accordingly, the individual may be prohibited from taking part in any activities, while lying supine. For example, in such a position, the individual is prohibited from viewing a television. Additionally, the individual is required to hold reading materials directly above their head when reading. Holding the reading materials in such a position may be uncomfortable to the individual. Additionally, attempting to read and/or watch television in the supine position may result in the individual altering the position of their head, thereby creating improper posture.

A need remains for a viewing apparatus that enables an individual confined to a supine position to view objects that are not positioned directly above the individual's head.

### SUMMARY OF THE INVENTION

In one embodiment, a viewing apparatus is provided including a cervical support for supporting the neck of a user while lying supine. A frame is removeably attached to the cervical support. The frame is adjustable relative to the cervical support. A pair of mirrors is coupled to the frame. Each of the mirrors is separately adjustable relative to the cervical support.

In another embodiment, a viewing apparatus is provided including an arm that removeably attaches to a support. The arm is adjustable relative to the support. A minor support is moveably attached to the arm. A pair of minors is coupled to the minor support. Each of the mirrors is separately adjustable relative to the arm.

### BRIEF DESCRIPTION OF THE DRAWINGS

The presently disclosed subject matter will be better understood from reading the following description of non-limiting embodiments, with reference to the attached drawings, wherein below:

FIG. 1 is a side perspective view of a viewing apparatus formed in accordance with an embodiment.

FIG. 2 is a front view of the viewing apparatus shown in FIG. 1.

FIG. 3 is a back view of the viewing apparatus shown in FIG. 1.

FIG. 4 is a side view of the viewing apparatus shown in FIG. 1 and in use.

FIG. 5 is a flowchart of a method for using the viewing apparatus shown in FIG. 1.

### DETAILED DESCRIPTION OF THE DRAWINGS

The foregoing summary, as well as the following detailed description of certain embodiments will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments provide a viewing apparatus having a cervical support for supporting the neck of a user while lying supine. The cervical support positions the user's line of view at an angle of approximately ninety degrees with respect to the user's body. A frame is removeably attached to the cervical support, and is adjustable relative to the cervical support. The frame includes an arm extending from the cervical support and a minor support joined to the arm. The arm is rotatable with respect to the cervical support. The mirror support is adjustable with respect to the arm. A pair of minors is coupled to the frame. Each of the mirrors is separately adjustable relative to the cervical support and the arm. One of the mirrors faces the head of the user and the other of the mirrors faces the feet of the user. In one embodiment, the mirrors are joined to the minor support. For example, the mirrors may be adjustably joined to the mirror support. The mirror support may include a first minor arm and a second minor arm, wherein one of the mirrors is rotatably attached to the first mirror arm, and the other of the minors is rotatably attached to the second minor arm. The minor support rotates with respect to the arm so that one the minors rotates with respect to the other mirror. For example, the second mirror arm may be rotatable with respect to the first mirror arm. The minors adjust the user's line of view with respect to the user' body. In one embodiment, the mirrors may adjust the user's line of view with respect to the user's body within a range of five to ninety degrees. For example, the mirrors may adjust the user's line of view toward the feet of the user.

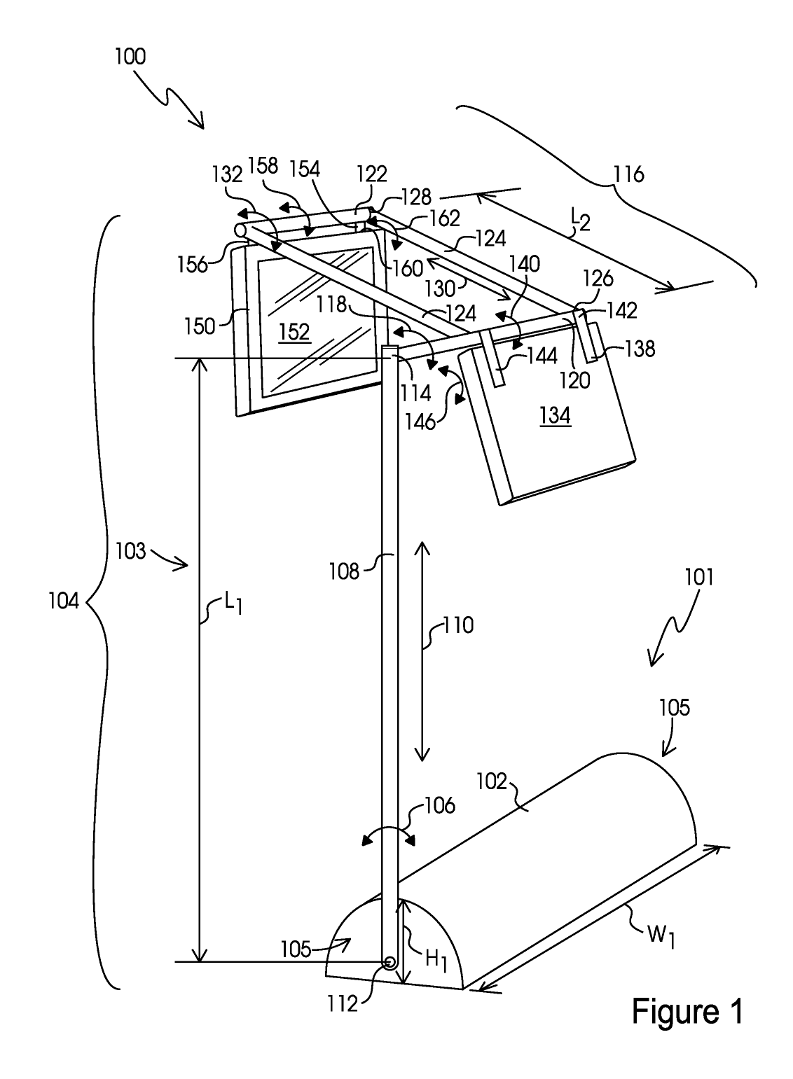

FIG. 1 is a side perspective view of a viewing apparatus 100 formed in accordance with an embodiment. The viewing apparatus 100 includes a front end 101 and a back end 103. The viewing apparatus 100 includes a cervical support 102. The cervical support 102 may be a foam roll or a combination of plastic and foam. The cervical support 102 has a substantially arched shape. The arched shape is configured to position under a neck of a user. In one embodiment, the cervical support 102 has a height H₁ of four to five inches. In one embodiment, the cervical support 102 has a height H₁ of less than five inches. The cervical support 102 may have a width W₁ of approximately 10 inches.

A frame 104 is connected to the cervical support 102. The frame 104 is joined to one of the sides 105 of the cervical support 102. Alternatively, the frame 104 may be joined to both sides 105 of the cervical support 102. In one embodiment, the frame 104 is removeably coupled to the cervical support 102. In such an embodiment, the frame 104 and/or the cervical support 102 may be used independently. The frame 104 is adjustably coupled to the cervical support 102. For example, the frame 104 may be rotatable with respect to the cervical support 102. In one embodiment, the frame 104 rotates with respect to the cervical support 102 about arrow 106. The frame 104 may be moved about the arrow 106 toward the front end 101 or the back end 103 of the viewing apparatus 100. Additionally, the frame 104 may include telescopic components that enable the frame 104 to be telescopically retracted toward the cervical support 102 or telescopically extended away from the cervical support 102 about an arrow 110.

The frame 104 includes an arm 108. Optionally, the frame 104 may include two arms 108 joined to each side 105 of the cervical support 102. The arm 108 extends from the cervical support 102. The arm 108 includes a support end 112 and a minor end 114. The arm 108 is removeably attached to the cervical support 102. In particular, the support end 112 is removeably attached to the cervical support 102. The arm 108 is adjustable with respect to the cervical support 102. For example, the arm 108 may be rotated about the arrow 106. The arm 108 may be rotated so that the minor end 114 rotates toward the front end 101 or the back end 103 of the viewing apparatus 100. In one embodiment, the arm 108 may be telescopic to alter a length L₁ of the arm 108. The arm 108 may be telescopically retracted toward the cervical support 102 or telescopically extended away from the cervical support 102 about arrow 110. In particular, the minor end 114 of the arm may be telescopically moved toward the cervical support 102 or away from the cervical support 102.

The frame 104 also includes a mirror support 116. The minor support 116 is joined to the mirror end 114 of the arm 108. The minor support 116 may be adjustably attached to the arm 108. For example, the minor support 116 may adjustable with respect to the cervical support 102 by rotating the mirror support 116 about the minor end 114 of the arm 108. The mirror support 116 may rotate about an arrow 118. The minor support 116 may rotate toward the front end 101 or the back end 103 of the viewing apparatus 100. In one embodiment, the minor support 116 may be moved toward or away from the cervical support 102 by telescopically adjusting the arm 108 of the frame 104.

The minor support 116 includes a first minor arm 120 and a second minor arm 122. The first minor arm 120 and the second mirror arm 122 are joined by connector arms 124. The first minor arm 120 is joined to the minor end 114 of the arm 108. The first mirror arm 120 may be rotated with respect to the arm 108. In particular, the first mirror arm 120 may rotate about the arrow 118. By rotating the first mirror arm 120, the mirror support 116 rotates with respect to the arm 108. Accordingly, the mirror support 116 is adjustable with respect to the cervical support 102.

The connector arms 124 include a first end 126 and a second end 128. The first ends 126 are joined to the first mirror arm 120 and the second ends 128 are joined to the second minor arm 122. In one embodiment, the connector arms 124 are telescopic to adjust a length L₂ of the connector arms 124. In particular, the second ends 128 may be moved about arrow 130 toward the first ends 126 or away from the first ends 126.

The second mirror arm 122 is joined to the second ends 128 of the connector arms 124. The second mirror arm 122 may be adjusted with respect to the cervical support 102. More particularly, the second mirror arm 122 may be adjusted with respect to the first minor arm 120. By telescopically adjusting the connector arms 124, the second mirror arm 122 may be moved about arrow 130 toward or away from the first ends 126 of the connector arms 124. Accordingly, the second minor arm 122 may be adjustable with respect to the first mirror arm 120 by being moved toward or away from the first mirror arm 120. Additionally, the second mirror arm 122 may rotate with respect to the second ends 128 of the connector arms 124. The second mirror arm 122 may rotate about arrow 132 so that the second mirror arm 122 is adjustable with respect to the first minor arm 120.

A viewing mirror base 134 is coupled to the first minor arm 120. The viewing mirror base 134 includes a viewing minor 136 (shown in FIG. 3). The viewing mirror 136 faces the back end 103 of the viewing apparatus 100. The viewing minor base 134 is joined to the first minor arm 120 by support members 138. In one embodiment, first ends 142 of the support members 138 rotate about the first mirror arm 120 to rotate the viewing minor 136 about arrow 140. Additionally, in one embodiment, the viewing minor base 134 rotates about second ends 144 of the support members 138 to rotate the viewing mirror 136 about arrow 146. As such, the viewing minor may be rotated toward the front end 101 or the back end 103 of the viewing apparatus 100 by rotating about arrow 140 and/or arrow 146. It should be noted that the viewing apparatus 100 may be formed without the viewing mirror base 134. In such an embodiment, the viewing minor 136 may be joined directly to the support members 138.

Accordingly, the viewing mirror 136 is adjustable with respect to the cervical support 102 through numerous mechanisms. For example, the viewing mirror 136 may adjusted with respect to the cervical support 102 by rotating the arm 108 about arrow 106 or telescopically adjusting the arm 108 about arrow 110. The viewing minor 136 is also adjustable with respect to the cervical support 102 and the arm 108 by rotating the minor support 116 about arrow 118, rotating the support members 138 about arrow 140, and/or rotating the viewing minor base 134 about the arrow 146.

A reflecting mirror base 150 is coupled to the second mirror arm 122. The reflecting minor base 150 includes a reflecting mirror 152. The reflecting mirror 152 faces the front end 101 of the viewing apparatus 100. The reflecting mirror base 150 is joined to the second minor arm 122 by support members 154. In one embodiment, first ends 156 of the support members 154 rotate about the second minor arm 122 to rotate the reflecting minor 152 about arrow 158. Additionally, in one embodiment, the reflecting mirror base 150 rotates about second ends 160 of the support members 154 to rotate the reflecting minor 152 about arrow 162. As such, the reflecting minor 152 may be rotated toward the front end 101 or the back end 103 of the viewing apparatus 100 by rotating about arrow 158 and/or arrow 162. It should be noted that the viewing apparatus 100 may be formed without the reflecting minor base 150. In such an embodiment, the reflecting mirror 152 may be joined directly to the support members 154.

Accordingly, the reflecting mirror 152 is adjustable with respect to the cervical support 102 through numerous mechanisms. For example, the reflecting minor 152 may adjusted with respect to the cervical support 102 by rotating the arm 108 about arrow 106 or telescopically adjusting the arm 108 about arrow 110. The reflecting mirror 152 is also adjustable with respect to both the cervical support 102 and the arm 108 by rotating the mirror support 116 about arrow 118, telescopically adjusting the connector arms 124 about arrow 130, rotating the second mirror arm 122 about arrow 132, rotating the support members 154 about arrow 158, and/or rotating the reflecting mirror base 150 about the arrow 162.

As such, the viewing minor 136 and the reflecting mirror 152 are also adjustable with respect to one another. For example, the viewing mirror 136 may be adjusted with respect to the reflecting minor 152 rotating the support members 138 about arrow 140 and/or rotating the viewing mirror base 134 about the arrow 146. Additionally, the reflecting mirror 152 may adjusted with respect to the viewing minor 136 by telescopically adjusting the connector arms 124 about arrow 130, rotating the second minor arm 122 about arrow 132, rotating the support members 154 about arrow 158, and/or rotating the reflecting mirror base 150 about the arrow 162.

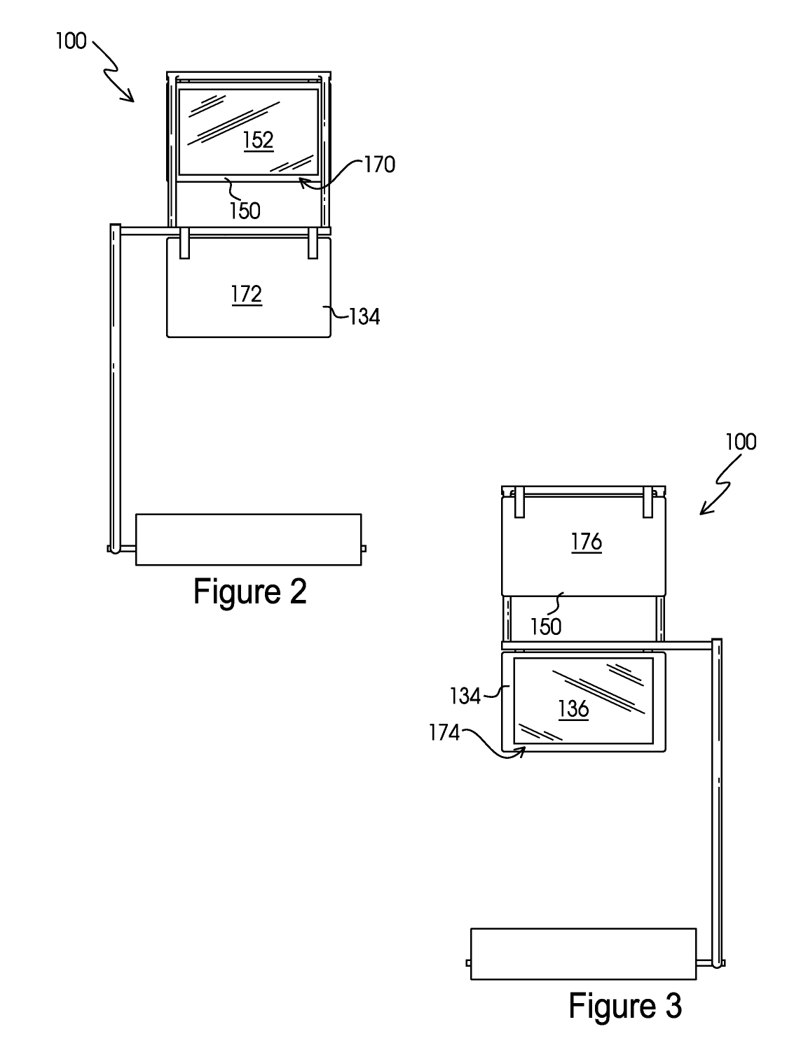

FIG. 2 is a front view of the viewing apparatus 100. The reflecting minor 152 is attached to a front end 170 of the reflecting mirror base 150. The reflecting minor 152 faces the front end 101 (shown in FIG. 1) of the viewing apparatus 100. The reflecting mirror 152 is visible from the front end 101 of the viewing apparatus 100. From the front end 101 of the viewing apparatus 100, a back end 172 of the viewing minor base 134 is visible. The viewing mirror 136 (shown in FIG. 3) is not visible from the front end 101 of the viewing apparatus 100.

FIG. 3 is a back view of the viewing apparatus 100. The viewing minor 136 is attached to a front end 174 of the viewing minor base 134. The viewing minor 136 faces the back end 103 of the viewing apparatus 100. The viewing mirror 136 is visible from the back end 103 (shown in FIG. 1) of the viewing apparatus 100. From the back end 103 of the viewing apparatus 100, a back end 176 of the reflecting mirror base 150 is visible. The reflecting mirror 152 (shown in FIG. 2) is not visible from the back end 103 of the viewing apparatus 100.

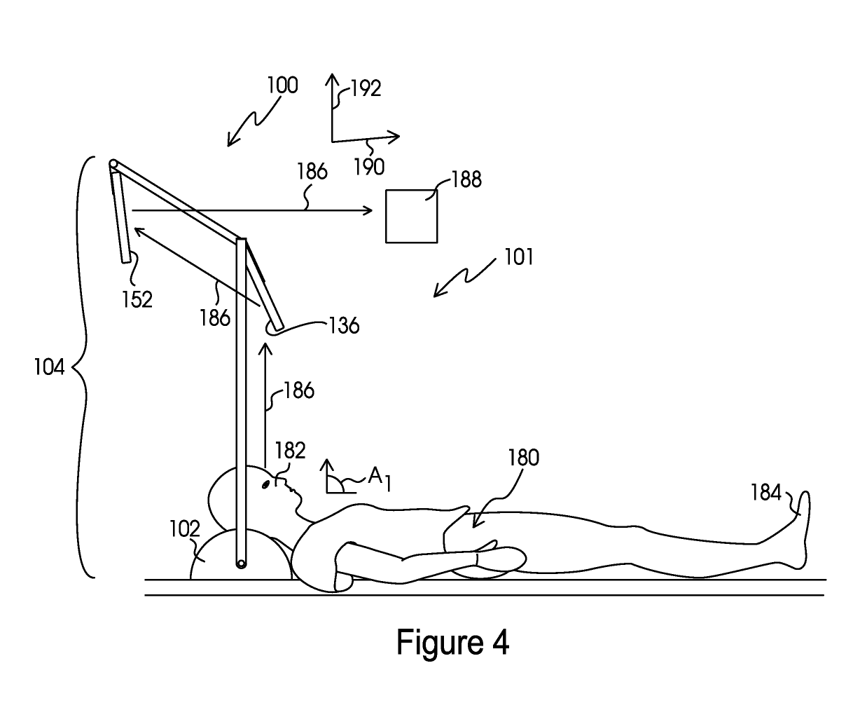

FIG. 4 is a side view of the viewing apparatus 100 in use by a user 180. A user's head 182 is positioned on the cervical support 102 so that the user's feet 184 are extended from the front end 101 of the viewing apparatus 100. The viewing minor 136 faces the head 182 of the user and the reflecting minor faces the feet 184 of the user 180. The cervical support 102 positions a line of view 186 of the user 180 at an angle A₁ of approximately ninety degrees with respect to the user's body. The user's line of view 186 may be altered by moving the user's eyes. In particular, the user 180 can adjust their line of view to the viewing mirror 136, while maintaining proper posture on the cervical support 102. The viewing mirror 136 and the reflecting mirror 152 adjust the user's line of view 186 with respect to the user's body. In particular, the viewing mirror 136 reflects the line of view 186 to the reflecting minor 152. The reflecting minor 152 then reflects the line of view 186 toward the feet 184 of the user 180.

The frame 104, the viewing mirror 136, and/or the reflecting minor 152 may be adjusted to adjust the user's line of view 186. The line of view 186 may be adjusted so that the user 180 may view an object 188 without adjusting a position of the user's head 182. For example, the object 188 may be a television, a book, or the like. Accordingly, the user 180 may view the object 188 while maintaining proper posture on the cervical support 102. In one embodiment, the frame 104, the viewing mirror 136, and/or the reflecting minor 152 may be adjusted to adjust the user's line of view 186 within a range of five to ninety degrees. Arrow 190 illustrates a five degree angle and arrow 192 illustrates a ninety degree angle.

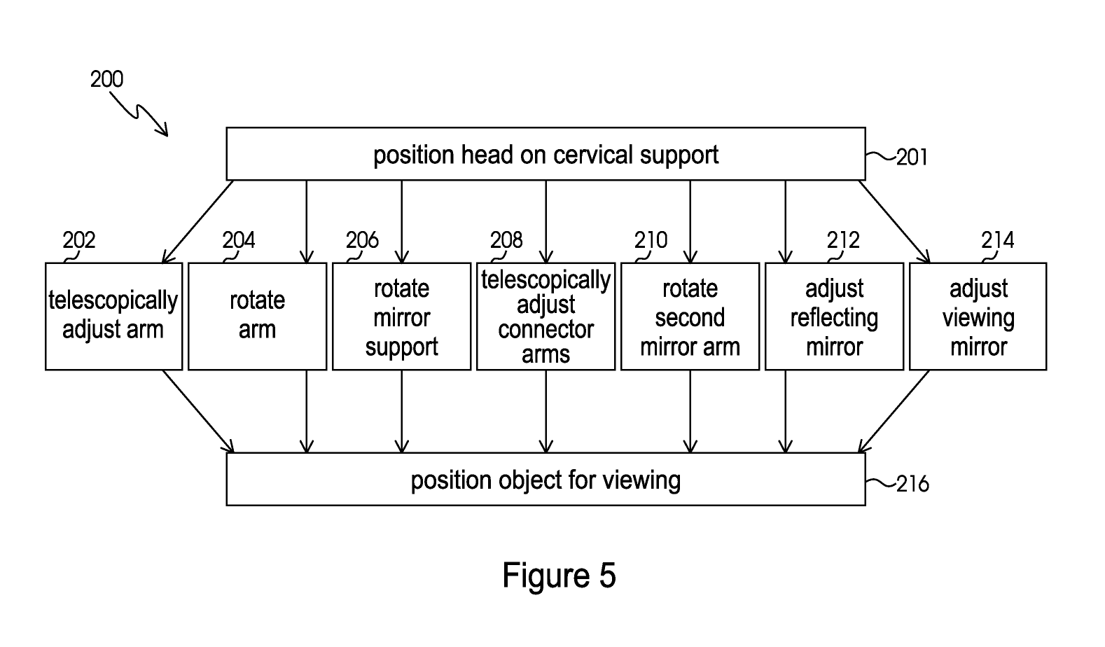

FIG. 5 is a flowchart of a method 200 for using the viewing apparatus 100. At step 201, the user 180 positions his head 182 on the cervical support 102. At step 202, the user 180 telescopically adjusts the arm 108 of the frame 104 by changing the length L₁ of the arm 108 about arrow 110. At step 204, the user 180 adjusts the arm 108 by rotating the arm 108 about arrow 106. At step 206, minor support 116 may be adjusted by rotating the first mirror arm 120 about the arrow 118. At step 208 the connector arms 124 may be telescopically adjusted by altering the length L₂ of the connector arms 124 about the arrows 130. At step 210, the second mirror arm 122 may be rotated with respect to the connector arms 124 about the arrow 132 to adjust a position of the reflecting minor 152. At step 212, the reflecting mirror 152 may be adjusted by rotating the support members 154 about arrow 158 and/or rotating the reflecting minor base 150 about the arrow 162. At step 214, the viewing minor 136 may be adjusted rotating the support members 138 about arrow 140 and/or rotating the viewing mirror base 134 about the arrow 146.

It should be noted the line of view 186 of the user 180 may be adjusted by any one of steps 202, 204, 206, 208, 210, 212, and/or 214 alone and/or in combination. At step 216, the user 180 positions the object 188 so that the user's line of view 186 is reflected in the viewing mirror 136 and the reflecting minor 152 to view the object.

The embodiments described herein provide a viewing apparatus that allows a person to lie down in a supine position and have a field of view not normally available to one lying down. The apparatus includes a cervical support to create proper cervical alignment. This offers a person the opportunity to rest the neck and provides therapeutic stretching of the neck and cervical spine while performing tasks that would normally be aggravating to the neck. Poor neck posture while computing or lying down and reading or watching television causes pain and stiffness in the neck and can aggravate conditions such as bulging cervical discs. The embodiments described herein allow these activities to be performed with proper cervical alignment, reducing pain and other neck problems.

The viewing apparatus includes a cervical support, such as a foam roll, or a combination of plastic and foam. The support typically has measurements of approximately 10 inches wide and 4 to 5 inches high (“high” being relative to where the cervical support contacts the neck). A frame, typically made of metal or plastic, may be connected to the cervical support, and the frame may be either rigid or flexible. The frame may include joints for adjustment. The frame may be attached to two adjustable minors that allow a user to select or change a viewing area. The minors may be upgraded with “viewing glasses” that are connected to a camera. The mirror and viewing glass options may be used as two options in the same frame, depending on the user's needs. The components of the viewing apparatus may be fabricated and connected to one another using typical methods for plastic, foam, metal, or other material.

In operation, the cervical support allows a user to lie down in a supine position with proper neck posture and/or proper cervical alignment. The viewing component of the apparatus may typically be approximately 4 to 6 inches above the user's eyes and above the user's head. The mirrors may be aligned to allow the user to view objects at angles from 5 degrees to 90 degrees, with 90 degrees being the normal view while lying on the back (i.e., looking at the ceiling). Because each person is different, the minors may be completely adjustable to suit any user's needs for viewing.

Typically, a person would lie down and place the cervical support under the cervical spine area. Appropriate portions of the attached frame over the person's head may then be adjusted so that the minors are visible. The user may then adjust the mirrors to bring the line of sight to a desired view, such as a television, a book, a laptop, or a computer pad.

Exemplary embodiments of a viewing apparatus are described above in detail. The components illustrated are not limited to the specific embodiments described herein, but rather, components of the system may be utilized independently and separately from other components described herein. For example, the cervical support and viewing component described above may also be used separately or in combination with other devices. For example, the viewing component may be used with other types of cervical supports, such as a posture pump, which is an inflatable support that forces the neck to curve upward when the user is in a supine position. Moreover, the frame may be removed from the apparatus so that the cervical support may be used as neck support only. Also, removal of the viewing component from the cervical support may allow the viewing component to be used in other sitting or lounging positions with proper cervical alignment. The viewing component may be used without the cervical support, such as at a desk chair or on a plane. In this way, a user may sit up with good posture, but view down at the knee area (at a laptop or book, for example) while preventing bad posture while looking down.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A viewing apparatus, comprising:
a cervical support for supporting a neck of a user while lying supine;
a frame removeably attached to the cervical support, wherein the frame is adjustable relative to the cervical support; and
a pair of mirrors coupled to the frame, wherein each of the minors is separately adjustable relative to the cervical support.

2. The viewing apparatus of claim 1, wherein the cervical support positions the user's line of view at an angle of approximately ninety degrees with respect to the user's body.

3. The viewing apparatus of claim 1, wherein the mirrors adjust the users line of view with respect to the user's body.

4. The viewing apparatus of claim 1, wherein the mirrors adjust the users line of view with respect to the user's body within a range of five to ninety degrees.

5. The viewing apparatus of claim 1, wherein the frame includes an arm extending from the cervical support and a mirror support joined to the arm, the minor support adjustable with respect to the arm.

6. The viewing apparatus of claim 1, wherein the frame includes an arm extending from the cervical support and a mirror support joined to the arm, the minors joined to the mirror support, the minor support rotatable with respect to the arm so that one the minors rotates with respect to the other mirror.

7. The viewing apparatus of claim 1, wherein the frame includes a minor support, the mirrors adjustably joined to the mirror support.

8. The viewing apparatus of claim 1, wherein the frame includes a minor support having a first mirror arm and a second minor arm, one of the minors rotatably attached to the first mirror arm, and the other of the minors rotatably attached to the second minor arm.

9. The viewing apparatus of claim 1, wherein the frame includes an arm extending from the cervical support and a mirror support joined to the arm and having a first minor arm and a second mirror arm, the second mirror arm rotatable with respect to the first mirror arm.

10. The viewing apparatus of claim 1, wherein the frame includes an arm extending from the cervical support, the arm rotatable with respect to the cervical support.

11. The viewing apparatus of claim 1, wherein one of the mirrors faces a head of the user and the other of the mirrors faces feet of the user.

12. The viewing apparatus of claim 1, wherein the mirrors adjust the user's line of view toward feet of the user.

13. A viewing apparatus, comprising:
an arm that removeably attaches to a support, wherein the arm is adjustable relative to the support;
a mirror support moveably attached to the arm; and
a pair of mirrors coupled to the mirror support, wherein each of the minors is separately adjustable relative to the arm.

14. The viewing apparatus of claim 13, wherein the mirrors adjust a users line of view with respect to the user's body.

15. The viewing apparatus of claim 13, wherein the mirror support is rotatable with respect to the arm so that one the minors rotates with respect to the other minor.

16. The viewing apparatus of claim 13, wherein each of the mirrors rotate with respect to the minor support.

17. The viewing apparatus of claim 13, wherein the mirror support includes a first minor arm and a second mirror arm, one of the mirrors rotatably attached to the first minor arm, and the other of the minors rotatably attached to the second minor arm.

18. The viewing apparatus of claim 13, wherein the mirror support includes a first minor arm and a second mirror arm, the second mirror arm rotatable with respect to the first mirror arm.

19. The viewing apparatus of claim 13, wherein the one of the mirrors faces a head of a user and the other of the minors faces feet of the user.

20. The viewing apparatus of claim 13, wherein the two minors adjust a user's line of view toward feet of the user.
